(19) United States
(12) Patent Application Publication
(10) Pub. No.: US 2019/0308899 A1
(43) Pub. Date: Oct. 10, 2019

(54) PROCESS FOR PRODUCING GLASS PRODUCTS AND APPARATUS SUITABLE FOR THE PURPOSE

(71) Applicant: Schott AG, Mainz (DE)

(72) Inventors: Stefan Schmitt, Stadecken-Elsheim (DE); Wolfgang Schmidbauer, Mainz (DE); Christian Müller, Mainz (DE); Frank-Thomas Lentes, Bingen (DE); Michael Hahn, Hohenstein (DE); Reinhard Männl, Mitterteich (DE); Hildegard Römer, Flörsheim (DE); Karin Naumann, Ober-Olm (DE)

(73) Assignee: Schott AG, Mainz (DE)

(21) Appl. No.: 16/379,332

(22) Filed: Apr. 9, 2019

(30) Foreign Application Priority Data
Apr. 10, 2018 (DE) 10 2018 108 418.8

(51) Int. Cl. C03B 5/225; C03B 5/235

(52) U.S. Cl. CPC C03B 5/225; C03B 5/235

(57) ABSTRACT

The present invention relates generally to a process for producing glass products and to an apparatus suitable for the purpose. In the process, a melting apparatus is provided with a melting tank for producing a glass melt from glass raw materials and a top furnace. Part of the surface of the melting region of the melting apparatus is covered with the glass raw materials and at least a small portion of the surface of the melting region is uncovered. In addition, energy is introduced in such a way that a vertical temperature difference can be established, such that the temperature of the glass melt at the base is greater than the temperature of the atmosphere in the top furnace.

### BACKGROUND OF THE INVENTION

### 1. Field of the Invention

The present invention relates generally to a process for producing glass products and to an apparatus suitable for the purpose.

### 2. Description of the Related Art

Processes for producing a glass melt have long been known. For this purpose, a suitable vessel, for instance a tank or a crucible, is selected and filled with batch or glass shards. The material supplied is heated, resulting in a liquid glass melt. The feeding of material and/or the drawing-off of liquid melt for the shaping operation can be effected here continuously or at particular time intervals.

Heat is introduced into the batch and into the glass melt, for example by heating from the top furnace space or by direct electrical heating by electrodes.

The melting of the batch and the time required for the purpose is determined in particular by the kinetics of the heat transfer. This can lead to various flows that arise as a result of the melting in the resultant glass melt.

Proportions of these flows can convey already significantly heated volume elements of the glass melt back below the batch and hence facilitate the continuous melting thereof from below. Only after the complete digestion of the batch can refining be effected, if required, in order to remove any bubbles from the melt. Specifically in the case of specialty glasses, the content of bubbles is generally an important quality feature, and a minimum number is the aim for the end product.

Even though what is desired is a high tank yield, i.e. a process of maximum efficiency for melting of glass, this cannot be achieved in an arbitrary manner via a higher energy input in the melting of batch or glass shards. An excessively high energy input can lead, for example, to premature activating of refining agent, such that it is no longer available during the actual refining phase. The correct adjustment of the energy input is complicated by the complex flow characteristics in the resultant glass melt.

Studies described, for example, in the publication Trier, W.: Glasschmelzöfen—Konstruktion and Betriebsverhalten [Glass Melting Furnaces—Construction and Characteristics of Operation], Springer-Verlag 1984, showed that there can be overlapping of throughput flow and convection flow, associated with geometry-related peculiarities of the flow of the glass in the glass melt tank. This can lead to complex mixing characteristics, which are also subject to changes, for instance in the event of a change in the batch recipe or the shard content.

Document DE 101 16 293 proposes a process in which convection is achieved by introducing jets of medium into the melt and arranging the jets such that a helix-like flow forms in the glass melt with an axis in process direction that migrates gradually toward the outlet. This spiral flow is generated primarily by the mechanical momentum of blast nozzles. However, such a process requires a relatively large melting aggregate; a certain length is at least required in order to be able to introduce the jets of medium in process direction. The achievable tank throughput is not very high either.

Document DE 10 2005 039 919 A1 describes a melt tank having a design selected with regard to the necessary minimum dwell time of the bubbles in order to optimize a refining process. The background lies in the reduction of refining agent contents in the production of glass ceramics.

What would be desirable, however, would be either to increase the throughput in existing melting apparatuses or else, especially for the design of new melting apparatuses, to have a smaller configuration with the same throughput, and hence ultimately to reduce the dwell time of the batch in the melting apparatus. In this way, it is possible to increase tank throughput, i.e. the amount of glass drawn off in relation to the volume of the melt tank.

At the same time, however, the quality of the glass products produced is at least not to be worsened, i.e. the yield is to at least remain the same.

What is needed in the art is a more efficient process for melting of glass.

### SUMMARY OF THE INVENTION

Compared to the processes known from the prior art, it is desired to convert a defined mass flow rate of glass raw materials, also referred to as tank throughput, to melt in a much smaller melting aggregate, with at least equal or even better quality. In the case of such a melting apparatus, it would accordingly be necessary to reduce the time for the melting of the batch and/or the shards, such that the throughput can be increased in relation to a given melting volume.

It would also be desirable if the time for the melting to be more specifically defined and even adjusted.

In this respect, a process for producing glass products, such as for continuously producing glass products, from a glass melt and by a melting apparatus suitable for performing the process is provided.

A process for production of glass products from a glass melt, which may be continuous, comprises the following steps:
providing glass raw materials, such as batch and/or glass shards;
heating the glass raw materials in a melting apparatus, the melting apparatus comprising a melting tank for producing a glass melt from the glass raw materials and a top furnace, at least part of a surface of a melting region of the melting apparatus being covered by the glass raw materials and at least a small portion of the surface of the melting region being not covered;
heating the melting apparatus in such a way that the temperature T_{G_BOD} of the glass melt at a base below the clear surface of the melting apparatus and the temperature T_{O} of the atmosphere in the top furnace are each at least 1300° C., where a vertical temperature difference T_{G_BOD}−T_{O} of at least 50° C. is established, and where the temperature of the glass melt at the base is greater than the temperature of the atmosphere in the top furnace, such that: T_{G_BOD}>T_{O}; and
discharging the glass melt from the melting tank. The discharged glass melt may have fewer than 1000 bubbles/kg having a diameter of greater than 50 μm.

As used herein, the term “melting apparatus” is understood to mean a plant or an aggregate for melting of glass. This melting apparatus may comprise one or more melting tanks, crucibles or other vessels for melting of glass. Merely for the sake of clarity, collective reference is made hereinafter to a melting tank.

The melting tank may comprise various regions, for example a charge region for charging of glass raw materials into the melting tank, a region for melting and/or a region for homogenizing or refining the glass melt. These regions may be separated in terms of construction or alternatively combined in terms of construction. For example, the charging and melting of the glass raw materials may take place in a first region, and the homogenizing or refining in a separate refining facility. This refining region may be divided from the charge region or melting region in construction terms by a wall at the base of the tank. Alternatively, or additionally, it is also possible for what is called a bridge wall that projects from above into the glass melt to be provided. If there is separation in construction terms, for instance into a melting tank and a refining tank, the various regions are connected to one another via suitable inlets that are also referred to passage or throat.

For particular applications, there may be a downstream so-called working tank or a distributor. Molten glass can be drawn off continuously or discontinuously and, after cooling to a predetermined working temperature, be formed or processed further.

In this respect, the term “glass raw material” means the material supplied or charged to the melting tank, comprising batch and/or glass shards. The charging can be effected by a suitable feed device, which may comprise a charging machine, into the charge region envisaged for the purpose of charging of the glass raw materials. The surface of the glass melt covered with glass raw materials is also referred to hereinafter as batch carpet.

In general, a closed upper cover of the melting apparatus, especially of the melting tank, is envisaged, which is also referred to as top furnace. This top furnace generally comprises side walls and a dome. In the case of fossil-fueled heating of the melting tank, the heating devices, for example gas burners, may be disposed in the side wall. The top furnace is generally configured here such that good heat transfer between the space defined by side walls and dome and the surface of the glass melt is enabled. Exemplary embodiments disclosed herein are of particularly good suitability for melting apparatuses having fossil-fueled heating in the top furnace.

The melting tank defines a volume designed for melting of the glass raw materials supplied.

This volume can generally be determined via what is called the melting area, which refers to the interface to the space and hence the surface of the glass melt, and the height, also referred to as bath depth. In the course of operation of the melting apparatus, within this volume is the glass melt which may comprise molten glass, but also constituents of the glass raw materials supplied, i.e. batch and/or glass shards.

The design of the melting apparatus, especially the geometry of the melting tank, but also the selection and arrangement of the heating devices for heating of the glass raw materials, are crucial for the efficiency, i.e. the tank throughput, and the lifetime of the plant. The tank throughput is determined essentially by the dwell time of the glass raw materials in the melting apparatus. The dwell time thus describes the residence time of the glass raw materials, i.e., for example, of the batch particles, in the flow system, i.e. in the melting apparatus, measured from the juncture of charging until departure via the outlet.

The dwell time can be ascertained for a melting apparatus by what are called pulse labelling methods, wherein what is called a tracer substance is supplied together with the glass raw materials and the time between the supply and the first increase in concentration at a withdrawal point, i.e. at the outlet, for example, is measured. Such a dwell time analysis for glass melting plants is described, for example, in the document Schippan, D.: Untersuchung des reaktionstechnischen Verhaltens in Behälterglaswannen mit Tracerversuchen [Study of Reaction-related Behaviour in Container Glass Tanks by Tracer Experiments], thesis approved by the Faculty for Mining, Metallurgy and Geological Sciences at the Rheinisch-Westfälische Technische Hochschule Aachen, 2003.

Alternatively, the minimum dwell time can also be calculated with the aid of mathematical simulation models.

Prior art melting methods have significant back flow of hot glass melt from the volume of the melting tank into the region of the raw material inlet. As a result, energy for melting of the raw materials is transported into the region of the raw material inlet and high shear rates for better melting of the raw materials induced by the high flow rates are generated. This is generally considered to be favorable since rapid melting of the glass raw materials and/or glass shards charged is generally desirable in order to achieve a comparatively high tank throughput, i.e. a high mass flow of glass raw materials. Against this background, the aim is a very high temperature in the top furnace, which may be 1300° C. or higher.

In the case of pure heating from above, for example by fossil-fueled heating devices, it is possible to establish a very high temperature in the top furnace. However, viewed from the surface of the glass melt, this decreases significantly in the direction of the base of the melting tank, which can lead to the abovementioned flows.

It would be better, by contrast, to configure the energy input such that more homogeneous, continuous heating of the volume with glass raw materials and/or glass melt is assured, since the significant backflows that develop ultimately lower the throughput and hence the efficiency of the melting apparatus. For instance, distinct backflows can lead to even greater forward flows and include the risk of generation of rapid and hence critical paths. This is understood to mean paths that run through the melt volume particularly rapidly and, in the most critical cases, also pass through zones with low average temperatures. These paths are considered to be particularly critical with regard to a possible reduction in quality in the product. A further disadvantage here is that bubbles can also get into the glass melt from the region of the interface layer between glass melt and glass raw materials and can be distributed throughout the volume.

Moreover, the temperature input into the glass melt by heating devices disposed solely in the top furnace is uneven and depends on the degree of coverage of the glass melt with glass raw materials supplied. The heat input is at least distinctly less favorable in those regions covered with glass raw materials.

Against this background, attempts have, to date, been made to minimize this degree of coverage of the surface with charged glass raw materials and to melt this small region as rapidly as possible with a high energy input.

Entirely unexpectedly, it has been found that it can be favorable under particular circumstances to aim for a significantly higher degree of coverage of the surface with glass raw materials, and at the same time to simultaneously establish a very specific temperature distribution in the glass melt.

The cause of this is considered to be that a higher degree of coverage of the surface with glass raw materials in combination with lower temperatures across the area covered with glass raw materials counteracts sintering at the surface, especially at the uncovered regions of the surface. It has been recognized that sintering of the surface has an unfavorable effect on the exit of gas from the glass melt beneath, in that it reduces or even entirely prevents exit of gas from the glass melt or from the interface layer. The effect of this is that gas remains in the glass melt and later can get into the glass product produced. Introduction of gases can barely be avoided since the gases are introduced into the glass melt in bound form or additionally via the glass raw materials.

In order to counteract this, in the context of the invention, an attempt is made to maximize the level of open pores in a maximum proportion of the surface of the glass melt. This can be effected by covering a maximum proportion of the surface with glass raw materials. This batch carpet can counteract sintering of the surface. In combination with a relatively low top furnace temperature by comparison with the temperature of the glass melt, the batch blanket remains open for longer.

In this way, it is surprisingly possible to significantly improve the exit of gas from the glass melt. Sintering, by contrast, leads to an enrichment of the near-surface layer with deposits similarly to slag formation, which can significantly reduce the exit of gas from the glass melt.

It has been found that the exit of gas can already be significantly improved when the coverage of the glass surface in the melting region with batch is at least 30%. A greater level of coverage increases the positive effect, and so more than 40% or more than 50% of the surface area available may be covered. It is undesirable for the entire surface to be covered with glass raw materials. The level of coverage should therefore also be not more than 80%, such as not more than 70% or not more than 60% of the available surface area.

In order to improve the process regime and to assure a more homogeneous energy input, what is envisaged in accordance with the invention is establishment of very specific temperatures and, resulting therefrom, very specific vertical and/or horizontal temperature differentials in the glass melt and/or in the top furnace. For this purpose, it is necessary to know the temperature at different points in the volume of the melting tank and also above it in the top furnace. These temperatures can be utilized for the design and in the later operation for closed-loop control of the melting apparatus.

For measurement of the temperatures in operation, it is possible to use suitable thermocouples, for instance immersed thermocouples or pyrometers, and for the design, alternatively or additionally, to use mathematical models as well. The design of melting apparatuses by mathematical models is described, by way of example, in document DE 10 2005 039 919 A1 and is hereby fully incorporated by reference.

In contrast with known processes, for the process regime provided according to the present invention, not only the temperature in the top furnace is taken into account, but also the temperature in the glass melt, i.e. in the volume of the melting tank, such as at different heights, especially in the near-base region of the glass melt and/or in a region in the glass melt adjoining the batch carpet and/or in a near-surface region of the glass melt which is uncovered. This makes it possible to further optimize the flow characteristics in the melting tank, and it is especially possible to reduce backflow of already molten glass.

This is based on the finding that flows in the glass melt are based to a significant degree on differences in density of the glass at different sites in the melting tank. As well as the influence on density as a function of temperature, bubbles in the glass or in the glass melt also have a considerable effect on density. Lower bubbles in the volume therefore lead to higher densities and hence to smaller differences in density relative to other regions in the melting tank.

In consequence, this means that the average dwell time of the glass raw materials in the melting tank can be reduced. It is thus possible to increase the efficiency of the melting apparatus and hence the tank throughput.

In order to control the flow characteristics in the melting tank as desired, in some embodiments the temperature of the glass melt is determined at the base below the clear surface of the melting apparatus T_{G_BOD}. In addition, the temperature T_{O} of the atmosphere in the top furnace is used.

In other words, the temperature T_{O} is the top furnace temperature, also called dome temperature, in the region above the glass surface covered with batch. This temperature can be measured by thermocouples that lead through the dome or else the side wall of the melting plant, the tips of which project into the furnace space but are still not in contact with the glass melt. According to the construction of the melting tank, the thermocouples may measure the temperature, for example, 1 m above the surface of the glass melt. Since the proportion of the glass surface covered with batch can vary, in some embodiments thermocouples are arranged in distribution at various sites over the surface, and those used for measurement are those above the specific coverage.

The temperature T_{G_BOD} is the glass temperature at the base below the clear surface, i.e. that not covered with glass raw materials. This temperature can be measured with thermocouples that lead through the base of the melting plant, the tips of which are arranged in direct contact with glass, i.e. protruding at least a little from the base and projecting, for example, 5 cm or 10 cm into the volume of the melting tank. Here too, multiple measuring elements arranged in distribution over the area of the base may be provided, which may be read individually.

According to the invention, the melting apparatus is heated in such a way that the temperature of the glass melt at the base T_{G_BOD} below the clear surface of the melting apparatus and the temperature T_{O} of the atmosphere in the top furnace is, in each case, at least 1300° C., where a vertical temperature difference T_{G_BOD}−T_{O} of at least 50° C. is established and where the temperature in the glass bath, i.e. in the glass melt, is greater than the temperature above it, such that: T_{G_BOD}>T_{O}. An even greater vertical temperature difference is even more favorable for the process. Accordingly, the vertical temperature difference T_{G_BOD}−T_{O} may be at least 100° C., such as at least 150° C.

In some embodiments, a very small horizontal temperature difference is established in the melting tank. This relates to the temperature T_{GuG_BOD} of the glass melt at the base below the batch carpet and the temperature T_{G_BOD} of the glass melt at the base below the clear surface. In this way, it is possible to influence near-base backflow of molten glass.

The temperature T_{GuG_BOD} is the glass temperature below the surface covered with glass raw materials at the base. This temperature can be measured with thermocouples that lead through the base of the melting plant, the tips of which are arranged in direct contact with glass, i.e. protrude at least a little from the base and project, for example, 5 cm or 10 cm into the volume of the melting tank.

In the context of the invention, it is favorable when this horizontal temperature difference between the temperature T_{GuG_BOD} of the glass melt at the base below the batch carpet and the temperature T_{G_BOD} of the glass melt at the base below the clear surface is less than 80° C. In this way too, it is possible to minimize difference in density in different zones in the volume of the melting tank and hence to counteract unwanted flows. In this case, it is even possible for a reduction in backflow to set in, such that the dwell time in the melting tank is reduced. It is useful when this temperature difference is less than 50° C., such as less than 20° C.

A crucial aspect in the design and the process regime of the melting apparatus is thus to approximate the temperature of the near-base glass melt below the batch carpet and the temperature of the near-base glass melt below the clear, i.e. uncovered, surface as closely as possible to one another, and in the ideal case to match them completely.

The term “clear surface” in this connection means that region which, in accordance with the invention, is not covered with glass raw materials in operation and is therefore essentially free of glass raw materials. It is therefore not impossible that charged glass raw materials, for example batch, can get into this region to a certain degree as a result of flows.

A small horizontal temperature differential in the near-base region of the glass melt is favorable in order to reduce the flows directed backward. Critical paths can be avoided in this way and the minimum dwell time of the glass raw materials can be increased.

The molten glass can then be drawn off from the melting tank in a discontinuous or continuous manner. In some embodiments, the molten glass can then be guided into a refining device in order to achieve an improvement in quality by a homogenization or a reduction in the bubbles therein.

It is surprisingly sufficient here when the quality of the glass in the region of the discharge of the glass melt from the melting tank conforms merely to an average quality. This means that a particular number of bubbles of a particular size per kilogram of glass at the outlet or transition region is considered to be comparatively uncritical and to be acceptable in the context of the invention.

It was customary to date, especially for the production of high-quality glass products, to directly provide a glass melt of maximum quality with a minimum number of bubbles at the outlet from the melting tank, which can then be guided from the melting tank into the refining device in order to remove the few bubbles still present.

It has now been found that it can in fact be favorable for the homogenization or refining of the glass melt when a certain number of bubbles having a certain size is still present in the glass charged. The effect of the refining can be improved when the bubbles have a certain size. In the case of bubbles that are too small, the effect of the refining is comparatively small. According to the invention, the discharged glass melt introduced into the refining device or refining tank may have fewer than 1000 bubbles/kg, such as fewer than 900 bubbles/kg or fewer than 800 bubbles/kg having a diameter of greater than 50 μm. The size figures reported here and hereinafter are based on the measurement of the bubbles in cold glass samples.

The refining can reduce the bubbles in the refined glass to fewer than 10 bubbles/kg having a diameter of greater than 50 μm, such as fewer than 5 bubbles/kg or fewer than 1 bubble/kg. This size parameter too is based on cold glass samples.

The process provided according to the invention can be used for production of different glass products comprising borosilicate, aluminosilicate or boroaluminosilicate glasses or lithium aluminum silicate glass ceramics. The compositions of the batch and/or of the glass shards can be selected correspondingly.

The composition of the glass raw materials may be free of refining agents. But it is also possible to add refining agents in the dimensions and types known to those skilled in the art, for example arsenic, antimony, tin, cerium, sulfate, chloride or any combinations thereof.

The process provided according to the invention enables establishment of a minimum dwell time tₘᵢₙ of the glass melt in the melting tank via the temperature regime. The dwell time tₘᵢₙ can be determined experimentally by the aforementioned tracer experiments. Alternatively, the minimum dwell time can also be calculated with the aid of mathematical simulation models.

This minimum dwell time tₘᵢₙ can be expressed in relation to what is called the average geometric dwell time t_{geo}.

This average geometric dwell time t_{geo} can be calculated from the volume of the melting tank and the volume flow throughput, i.e. the amount of glass raw materials supplied per unit time. Accordingly, the average geometric dwell time t_{geo} is ascertained from the ratio of tank volume to volume supplied per unit time.

It has been found to be favorable when the ratio of a minimum dwell time tₘᵢₙ of the glass melt in the melting tank to the average geometric dwell time t_{mg} of the glass melt in the melting tank t_{mg}/tₘᵢₙ is not more than 6, such as not more than 4 or not more than 3.

The absolute value of the average geometric dwell time t_{geo} should also be viewed in this connection, which may be less than 100 h and hence ensures a high tank throughput. It is even possible to establish average geometric dwell time t_{geo} of less than 70 h or less than 40 h.

The heating of the glass raw materials in the melting apparatus may comprise electrical and/or fossil-fueled heating devices known to those skilled in the art. Melting apparatuses with fossil-fueled heating in the top furnace may be particularly well-suited, and can be provided in conjunction with additional electrical heating. A known example is to use gas burners in the top furnace for heating of the glass melt.

Heating solely via heating devices disposed in the top furnace has been found to be comparatively unfavorable for the present invention since the temperature input into the glass melt is inhomogeneous and proceeds solely from the surface in the depth direction, as a result of which the abovementioned backflows can develop within the volume.

Furthermore, in this case, i.e. that of pure heating from above from the top furnace, the temperature input is correlated to the degree of coverage of the glass melt with glass raw materials supplied, and is less favorable in regions in which there is no coverage than in the clear regions. This can lead to significant vertical flow at the transition region between a covered surface and a clear surface, as a result of which rotation vortices about a horizontal axis can develop in the glass melt, which have likewise been found to be unfavorable for the flow characteristics overall. The effect of a flow that develops in this transition region can be that transport of glass melt in flow direction is made much more difficult. This can have an unfavorable effect on the tank throughput.

In some embodiments, the heating device therefore further comprises an electrical heater, such as an additional electrical heater, which allows more exact closed-loop control of the energy input and hence a more homogeneous and better temperature regime in the glass melt. The electrical heating may comprise electrodes, for example.

According to some embodiments, for the electrical heating, full-area electrical heating may be provided, which may comprise what are called side, block or plate electrodes and hence allows a particularly homogeneous heat input. This electrical full-area heating may also be disposed on the side wall of the melting tank, such as at different heights in the glass melt, in order to control the temperature input, for instance as a function of the specific extent and thickness of the batch carpet.

The side, block or plate electrodes may have been manufactured from or may comprise the materials known to the person skilled in the art, such as molybdenum, tungsten, tin oxide, platinum alloys, or else other customarily used materials.

In some embodiments, the heating device is accordingly designed such that the glass melt is heated electrically at least below the surface covered with the glass raw materials.

As a result, it is possible to dispense with use of blast nozzles and/or rod electrodes in the volume of the glass melt, which can lead to point heat input and hence to unfavorable flow conditions. Use of rod electrodes close to the side walls, for instance, is unaffected thereby.

A melting apparatus suitable for the performance of the process may also have further components known to those skilled in the art. The melting apparatus may therefore further comprise:
a charge region, which may have a feed device for the charging of the glass raw materials, comprising batch and/or glass shards;
a discharge device for discharging the glass melt, such as a throat;
electrodes for electrical heating, such as side, block or plate electrodes;
a bridge wall; and
an immersed barrier designed with or without separation in the top furnace.

This enumeration is purely illustrative and should not be regarded as conclusive.

Also provided according to the present invention is a melting apparatus for production of glass products from a glass melt, which may be continuous, and for production of glass products comprising borosilicate, aluminosilicate or boroaluminosilicate glasses or lithium aluminum silicate glass ceramics. The melting apparatus comprises:
a melting tank for generating a glass melt from glass raw materials and a top furnace;
a feed device for the insertion of the glass raw materials, where the feeding is effected in such a way that at least part of the surface of the melting region of the melting apparatus can be covered with the glass raw materials fed in;
a heating device for heating the glass melt in such a way that the temperature T_{G_BOD} of the glass melt at the base below the clear surface of the melting apparatus and the temperature T_{O} of the atmosphere in the top furnace is at least 1300° C. in each case, where a vertical temperature difference T_{G_BOD}−T_{O} of at least 50° C. is established, and where the temperature of the glass melt at the base is greater than the temperature of the atmosphere in the top furnace, such that: T_{G_BOD}>T_{O}; and
a discharge device for discharging the glass melt from the melt tank, where the discharged glass melt may have less than 1000 bubbles/kg having a diameter of greater than 50 μm.

In addition, a refining device for homogenizing or refining the discharged glass melt may be provided. In this refining device, the bubbles in the refined glass can be reduced to fewer than 10 bubbles/kg having a diameter of greater than 50 μm, such as to fewer than 5 bubbles/kg or to fewer than 1 bubble/kg having a diameter of greater than 50 μm.

The heating device may comprise fossil-fueled and/or electrical heating devices, as well as electrical additional heaters. The energy introduced may be introduced by a combination of fossil-fueled and electrical heating devices; purely fossil-fueled or purely electrical heating is not considered to be favorable. This combination allows, in an excellent manner, implementation of a high energy input, for example by fossil-fueled heating in the top furnace, with a very precisely controllable energy input, for instance by electrical heating by the side walls, and hence reliable achievement of the desired temperature distributions. Thus, the advantages of the two heating devices complement one another ideally.

It has been found that a particularly precise temperature regime is possible when the energy input for heating of the glass melt is effected by electrical and fossil-fueled heating in a particular ratio to one another. In some embodiments, at least 25% and at most 75% of the energy input is by electrical heating devices, such as at least 30% and at most 70% or at least 40% and at most 60%. The proportion of the energy input up to 100% can then be provided by fossil-fueled heating devices.

For the electrical heating, electrical heating that acts over the full area may therefore be provided, which may comprise side, block or plate electrodes and hence allows a homogeneous heat input and a homogeneous temperature distribution in the glass melt. These may also be disposed on the side of the melting tank in order to improve the temperature input and to promote a very substantially homogeneous horizontal temperature distribution, especially in the near-base region of the melting tank.

In some embodiments, the heating device is designed such that the glass melt is heated electrically below the surface covered with the glass raw materials.

The feed device may comprise a charging machine for feeding and charging of glass raw materials, i.e. of batch and/or glass shards, and may be designed such that a large portion of the surface of the melting region of the melting apparatus can be covered by the glass raw materials fed in. The glass raw materials can be fed in by known devices or charging machines, e.g., screw chargers, push chargers, vibrating channels, pushers, or other devices in customary use.

In this way, a majority of the surface is covered with glass raw materials, such as more than 30%, more than 40%, or more than 50% of the available surface area.

Embodiments provided according to the invention allow increased throughput in existing melting apparatuses or else, especially for the design of new melting apparatuses, smaller configuration thereof for the same throughput and hence ultimately reduction in the average or geometric dwell time of the batch in the melting apparatus. In this way, it is possible to increase tank throughput, i.e. the amount of glass drawn off in relation to the volume of the melting tank.

The quality of the glass products produced does not worsen as a result of the process, meaning that the yield remains at least the same. In various experiments, it was found that a distinct improvement in the glass quality is possible when the degree of coverage is increased to 30% or more under otherwise identical boundary conditions.

Exemplary embodiments provided according to the invention therefore provide a highly efficient process for melting of glass and for production of high-quality glass products.

The time for the melting of the batch and/or the shards can be significantly reduced, such that the throughput can be increased in relation to a given melting volume. In some embodiments, it is possible to specifically define and adjust the time for the melting.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a graph illustrating the bubble content and temperature distribution achievable for a glass type utilizing an exemplary embodiment provided in accordance with the present invention;

FIG. 2 is a graph illustrating the bubble content and temperature distribution achievable for another glass type utilizing an exemplary embodiment provided in accordance with the present invention;

FIG. 3 is a graph illustrating the bubble content and temperature distribution achievable for another glass type utilizing an exemplary embodiment provided in accordance with the present invention;

FIG. 4 is a graph illustrating the bubble content and temperature distribution achievable for another glass type utilizing an exemplary embodiment provided in accordance with the present invention;

FIG. 5 is a longitudinal sectional view of an exemplary embodiment of a melting apparatus provided in accordance with the present invention;

FIG. 6 is a schematic view of another exemplary embodiment of a melting apparatus in a longitudinal section, provided in accordance with the present invention;

FIG. 7 is a schematic view of another exemplary embodiment of a melting apparatus in a longitudinal section with a melting tank and a refining tank, provided in accordance with the present invention;

FIG. 8 is a top view of an exemplary embodiment of a two-part melting apparatus with side electrodes, provided in accordance with the present invention;

FIG. 9 illustrates the melting apparatus from FIG. 8 in a longitudinal section;

FIG. 10 is a top view of another exemplary embodiment of a two-part melting apparatus with side electrodes that has a melting output of more than 25 tons/day, with electrodes provided in a transverse arrangement in the melting tank, provided in accordance with the present invention;

FIG. 11 illustrates the melting apparatus of FIG. 10 in a longitudinal section;

FIG. 12 is a top view of another embodiment of a two-part melting apparatus with side electrodes that has a melting output of more than 25 tons/day, with provision of electrodes in a longitudinal arrangement in the melting tank, provided in accordance with the present invention; and

FIG. 13 illustrates the melting apparatus of FIG. 12 in a longitudinal section.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

In the detailed description of exemplary embodiments that follows, for the sake of clarity, identical reference numerals denote essentially identical parts in or on these embodiments. For better illustration of the invention, however, the exemplary embodiments shown in the figures are not always drawn to scale.

The process according to the invention for production of glass products from a glass melt, which may be continuous, comprises the following steps: providing glass raw materials, such as batch and/or glass shards; heating the glass raw materials in a melting apparatus, the melting apparatus comprising a melting tank for producing a glass melt from the glass raw materials and a top furnace, at least part of the surface of the melting region of the melting apparatus being covered by the glass raw materials and at least a small portion of the surface of the melting region being not covered; heating the melting apparatus in such a way that the temperature T_{G_BOD} of the glass melt at the base below the clear surface of the melting apparatus and the temperature T_{O} of the atmosphere in the top furnace are each at least 1300° C., where a vertical temperature difference T_{G_BOD}−T_{O} of at least 50° C. is established, and where the temperature of the glass melt at the base is greater than the temperature of the atmosphere in the top furnace, such that: T_{G_BOD}>T_{O}; and discharging the glass melt from the melting tank, where the discharged glass melt may have fewer than 1000 bubbles/kg having a diameter of greater than 50 μm.

The present process is based on the optimization of the energy input with the aim of improving the flow conditions during the melting of the glass raw materials in such a way that the tank throughput can be increased.

The energy input affects very important parameters of a melting apparatus for glass. Table 1 below compares various important parameters for melting apparatuses selected by way of example. These parameters are:
TP: throughput, measured in tons/day [t/d],
MA: melting area, surface area of the volume of the melting tank available for the glass melt, measured in m²,
Spec. MA: specific melting area [t/m²/d],
tₘᵢₙ: minimum dwell time of the melting plant in hours [h], defines the time between charging of the tracer substance and the first increase in concentration at the discharge point,
t_{geo}: mean geometric dwell time of the melting plant in hours [h], calculated from the tank volume and the volume flow throughput, and
t_{geo}/tₘᵢₙ: ratio of the minimum dwell time tₘᵢₙ of the glass melt in the melting tank to the average geometric dwell time t_{mg} of the glass melt in the melting tank.

TABLE 1
Throughput, melting area and dwell times of selected melting tanks

| Designation of the | TP | MA | Spec. MA | tₘᵢₙ | t_{geo} | |
|---|---|---|---|---|---|---|
| aggregate | [t/d] | [m²] | [t/m²/d] | [h] | [h] | t_{geo}/tₘᵢₙ |
| Schippan | | | | | | |
| Tank A 1) | | | | | | |
| B1 | 234 | 75 | 3.12 | 8 | 34 | 4.3 |
| B2 | ″ | ″ | ″ | 8 | 31.7 | 4.0 |
| B3 | ″ | ″ | ″ | 7 | 31.5 | 4.5 |
| B4 | ″ | ″ | ″ | 7 | 31.8 | 4.5 |
| Schippan | | | | | | |
| Tank B 1) | | | | | | |
| 2/0 | 355 | 96.4 | 3.68 | 2-2.5 | 22.8 | 9.1-11.4 |
| 2/1 | ″ | ″ | ″ | 2.5-3.5 | 21.5 | 6.1-8.6 |
| 2/2 | ″ | ″ | ″ | 3.5 | 22 | 6.3 |
| Schippan | | | | | | |
| Tank C 1) | | | | | | |
| H1 - 3/1 | 280 | 94 | 2.98 | 4 | 19.5 | 4.9 |
| H1 - 3/2 | ″ | ″ | ″ | 4 | 26.5 | 6.6 |
| H1 - 3/3 | ″ | ″ | ″ | 10 | 38 | 3.8 |
| H3 - 3/1 | ″ | ″ | ″ | 6 | 29.5 | 4.9 |
| H3 - 3/2 | ″ | ″ | ″ | 5 | 29.5 | 5.9 |
| H3 - 3/3 | ″ | ″ | ″ | 9 | 34.5 | 3.8 |
| H5 - 3/1 | ″ | ″ | ″ | 6 | 31 | 5.2 |
| H5 - 3/2 | ″ | ″ | ″ | 5 | 26.5 | 5.3 |
| H5 - 3/3 | ″ | ″ | ″ | 7 | 27 | 3.9 |
| Schippan | | | | | | |
| Tank D 1) | | | | | | |
| H1 - 3/1 | 330 | 94 | 3.51 | 4.5 | 23.3 | 5.2 |
| H1 - 3/2 | ″ | ″ | ″ | 5.5 | 32 | 5.8 |
| H1 - 3/3 | ″ | ″ | ″ | 14 | 40 | 2.9 |
| H2 - 3/1 | ″ | ″ | ″ | 4.5 | 24.3 | 5.4 |
| H2 - 3/2 | ″ | ″ | ″ | 4.5 | 24.8 | 5.5 |
| H2 - 3/3 | ″ | ″ | ″ | 8.5 | 31.6 | 3.7 |
| H5 - 3/1 | ″ | ″ | ″ | 5.5 | 31 | 5.6 |
| H5 - 3/2 | ″ | ″ | ″ | 4.5 | 24 | 5.3 |
| H5 - 3/3 | ″ | ″ | ″ | 7 | 33 | 4.7 |
| TECO 2) | 272 | 84 | 3.2 | — | 42 | — |
| Trier 3) | 106.5 | 133 | 0.8 | 6.5 | 65 | 10 |
| VES 4) | 14 | 7.5 | 1.9 | 4-5 | about | 7-8.8 |
| Rasotherm glass | | | | | 35 | |
| Oberland W7 5) | 246 | 71 | 3.5 | 4.5 | 19.5 | 4.3 |
| | 220 | 71 | 3.1 | 4-5 | 21.8 | 4.4-5.5 |

The data listed come from the following documents:
1) Schippan, D.: Untersuchung des reaktionstechnischen Verhaltens in Behälterglaswannen mit Tracerversuchen,
   thesis approved by the Faculty for Mining, Metallurgy and Geological Sciences at the Rheinisch-Westfälische Technische Hochschule Aachen, 2003;

### Tank A: p. 72, 75 and 77-84

### Tank B: p. 92, 95, 102-103

### Tank C: p. 109, 111, 116, 120, 122

### Tank D: p. 124

2) Tecoglas, W. R. Seitz, C. W. Hibscher: “Design Considerations for All-electric Melters”, 41st Conference on Glass Problems, November 1980, Columbus, Ohio
3) Trier, W.: Glasschmelzöfen—Konstruktion and Betriebsverhalten, Springer-Verlag 1984,
4) Hippius, W., Linz, H.-J., Philipp, G.: “Untersuchung von Abhangigkeiten zwischen Verweilzeitverteilung des Glases im Schmelzaggregat and technologischen Parametern bei der vollelektrischen Schmelze” [Study of Dependences between Dwell Time Distribution of the Glass in a Melting Aggregate and Technological Parameters in the All-Electric Melt], in: Fundamentals of Glass Science and Technology 1993, Proceedings of the Second Conference of the European Society of Glass Science and Technology; Venice, Italy, 21-24 Jun. 1993
5) Bauer, J.: “Verweilzeitanalysen an einer Glasschmelzwanne” [Dwell Time Analyses in a Glass Melting Tank],

### HVG Communication No. 1903, Frankfurt

The examples of important parameters for melting tanks shown in the overview show smaller and larger aggregates, for instance with a throughput of 14 t/d (VES Rasotherm glass) up to large-scale plants having a daily throughput of up to 355 t/d (Schippan B 2/0). In the selected plants, different glasses are melted and processed to give different glass products. Therefore, the consideration includes, for example, float glass plants, but also smaller plants, for example for production of borosilicate glass articles.

The minimum dwell time tₘᵢₙ is at least 2 h up to aggregates with more than 11 h; the geometric dwell times t_{geo} are at values between 19.5 h up to more than 60 h. This results in ratio values t_{geo}/tₘᵢₙ of 3.7 up to values such as 10.

However, it should be taken into account here that the achievable values should always be viewed in combination with the achievable glass qualities. The plants having small values that are mentioned as examples do not attain the required glass qualities. A rise in the throughput alone without constant quality ultimately leads to a lower efficiency of the melting.

The temperature distribution in the selected illustrative melting apparatuses from Table 1 is shown in Table 2. The following values are summarized in Table 2:

T_{GuG}: glass temperature below the batch. Measured by immersed thermocouples from the top 20 cm through the batch, or alternatively calculated with the aid of mathematical simulation models.

T_{GuG_Bod}: glass temperature below the batch at the base. Measured by thermocouples that lead through the base of the melting plant, the tips of which are arranged in direct contact with glass.

T_{G_OF}: glass temperature at the free glass bath surface, i.e. without batch coverage. Measured by immersed thermocouples from the top or by pyrometers with wavelengths of low glass penetration depth.

T_{G_Bod}: glass temperature at the base below the clear glass bath surface. Measured by thermocouples that lead through the base of the melting plant, the tips of which are arranged in direct contact with glass.

T_{O}: top furnace temperature (=dome temperature) in the region above the glass surface covered with batch. Measured with thermocouples that lead through the dome (or the sidewall) of the melting plant, the tips of which project into the furnace space.

TABLE 2
Temperatures of the example tanks

| | T_{O} | T_{GuG} | T_{GuG Bod} | T_{G OF} | T_{G Bod} |
|---|---|---|---|---|---|
| | [° C.] | [° C.] | [° C.] | [° C.] | [° C.] |
| Schippan | 1450-1500 | — | 1250 | 1550-1590 | 1250-1260 |
| Tank A 1) | | | | | |
| Schippan | — | — | 1200-1300 | 1550 | 1300 |
| Tank B 1) | | | | | |
| Schippan | 1545-1560 | — | 1055 | 1565-1595 | 1080-1090 |
| Tank C 1) | | | | | |
| Schippan | 1545-1560 | — | 1055 | 1565-1595 | 1080-1090 |
| Tank D 1) | | | | | |
| TECO 2) | 50 | 1345-1425 | 1380-1410 | — | — |
| Trier 3) | — | — | — | — | — |
| VES 4) | cold | — | — | — | — |
| Rasotherm | | | | | |
| glass | | | | | |
| Oberland | — | — | — | — | — |
| W7 5) | | | | | |

Table 3 below summarizes successful working examples of melting apparatuses provided according to the invention with important parameters. This shows, among other parameters:

Bubble content_SW: glass quality in bubbles/kg at the outlet of the melting region or melting tank. The assessment includes bubbles with a size, this being understood to mean the greatest extent of a bubble in any direction, of about 50 μm or greater and at most 1000 μm.

Bubble content_LW: glass quality in bubbles/kg at the outlet of the refining region or the refining tank.

Coverage_SW: area proportion of the coverage of the surface of the melting region or of the melting tank with batch in % of the total area of the melting region or the melting tank.

Working examples 1-5 shown relate to the production of glass products of different glass types. The daily throughputs of working examples 1-4 shown are comparatively small, as also indicated by the comparatively small melting areas. The degree of coverage Coverage_SW chosen in the working examples was relatively high and is at least 40% or more and goes up to 60%, meaning that more than half of the surface area available is covered with glass raw materials.

This results in an excellently low ratio of the dwell times I_{geo}/Iₘᵢₙ, the maximum of which is 3.1 and which goes down to a value of 1.9 and hence very closely approaches an ideal value of 1.0.

The glass quality at the end of the melting region is in a region of 300 bubbles/kg, in some cases even considerably lower. In the working examples, the glass is to be supplied to a refining operation. This is effected at a temperature of 1640° C. (examples 1-4) or of 1600° C. (example 5). It is found that a very high quality after refining of less than 1 bubble/kg, such as less than 0.1 bubble/kg, can be achieved.

TABLE 3
Successful working examples of melting apparatuses provided according to the invention

| | Glass | TP | MA | Spec.MA | tₘᵢₙ | t_{geo} | t_{geo}/tₘᵢₙ | Coverage_SW |
|---|---|---|---|---|---|---|---|---|
| Example | type | [t/d] | [m²] | [t/m²/d] | [h] | [h] | [h] | % |
| 1a | A | 0.35 | 0.22 | 1.6 | 3.3 | 9.2 | 2.8 | 50-60 |
| 1b | A | 0.35 | 0.22 | 1.6 | 3 | 9.2 | 3.1 | 40-50 |
| 2 | B | 0.43 | 0.22 | 2 | 3.5 | 7 | 2.0 | 50-60 |
| 3 | C | 0.43 | 0.22 | 2 | 4 | 7.5 | 1.9 | 50-60 |
| 4 | D | 0.43 | 0.22 | 2 | 3.5 | 7.5 | 2.2 | 50-60 |
| 5 | B | 12 | 5.84 | 2 | 8 | 25 | 3.1 | 40-60 |

| | | | | | | | Bubble | Bubble |
|---|---|---|---|---|---|---|---|---|
| | Glass | T_{O} | T_{GuG} | T_{GuG}_{_{—}}_{Bod} | T_{G}_{_{—}}_{OF} | T_{G}_{_{—}}_{Bod} | content_SW | content_LW |
| Example | type | [° C.] | [° C.] | [° C.] | [° C.] | [° C.] | Bl/kg | Bl/kg |
| 1a | A | 1560 | 1600 | 1640 | 1600 | 1640 | <10 | <0.1 |
| 1b | A | 1600 | 1610 | 1640 | 1620 | 1640 | 300 | <0.1 |
| 2 | B | 1500 | 1570 | 1640 | 1580 | 1640 | <10 | <0.1 |
| 3 | C | 1560 | 1600 | 1640 | 1610 | 1640 | 80 | <0.1 |
| 4 | D | 1560 | 1600 | 1640 | 1600 | 1640 | <100 | <1 |
| 5 | C | 1500 | 1480 | 1530 | 1530 | 1570 | 100 | <1 |

Finally, Table 4 summarizes further working examples that were unsuccessful. A much lower degree of coverage was chosen here, for instance between 10% and 30%. It is found that the ratio t_{geo}/tₘᵢₙ is essentially distinctly less favorable. At a coverage of 10-20%, for example, only a t_{geo}/tₘᵢₙ ratio of 6.1 can be achieved.

The achievable glass quality is also much poorer, even though refining has likewise been conducted at a temperature of 1640° C. It is possible to observe here that the bubble content, i.e. the number of bubbles/kg measured at the outlet of the melting region or of the melting tank, is several orders of magnitude above that from the successful working examples, in the most favorable case about 8000 bubbles/kg, but even up to 100 000 bubbles/kg. Even in the glass after refining, there is much more than 1 bubble/kg.

TABLE 4
Unsuccessful working examples

| | Glass | TP | MA | Spec.MA | tₘᵢₙ | t_{geo} | | Coverage_SW |
|---|---|---|---|---|---|---|---|---|
| Example | type | [t/d] | [m²] | [t/m²/d] | [h] | [h] | t_{geo}/tₘᵢₙ | % |
| 1 | A | 0.35 | 0.22 | 1.6 | 2.5 | 9.2 | 3.7 | 20-30 |
| 2 | A | 0.35 | 0.22 | 1.6 | 1.5 | 9.2 | 6.1 | 10-20 |
| 3 | C | 0.43 | 0.22 | 2 | 2.4 | 7.5 | 3.1 | 10-30 |
| 4 | C | 0.43 | 0.22 | 2 | | 7.5 | | 10-30 |
| 5a | D | 0.43 | 0.22 | 2 | 2.2 | 7.5 | 3.4 | 10-30 |
| 5b | D | 0.43 | 0.22 | 2 | 2.0 | 7.5 | 3.8 | 10-30 |

| | | | | | | | Bubble | Bubble |
|---|---|---|---|---|---|---|---|---|
| | Glass | T_{O} | T_{GuG} | T_{GuG@Bod} | T_{G@OF} | T_{G@Bod} | content_SW | content_LW |
| Example | type | [° C.] | [° C.] | [° C.] | [° C.] | [° C.] | Bl/kg | Bl/kg |
| 1 | A | 1640 | 1580 | 1640 | 1640 | 1640 | 11 000 | 5 |
| 2 | A | 1680 | 1600 | 1560 | 1630 | 1560 | 55 000 | 10 |
| 3 | C | 1680 | 1590 | 1560 | 1620 | 1560 | 90 000 | 60 |
| 4 | C | 1640 | 1620 | 1640 | 1640 | 1640 | 10 000 | 10 |
| 5a | D | 1640 | 1620 | 1640 | 1640 | 1640 | 8000 | 13 |
| 5b | D | 1680 | 1600 | 1560 | 1640 | 1560 | >100 000 | 50 |

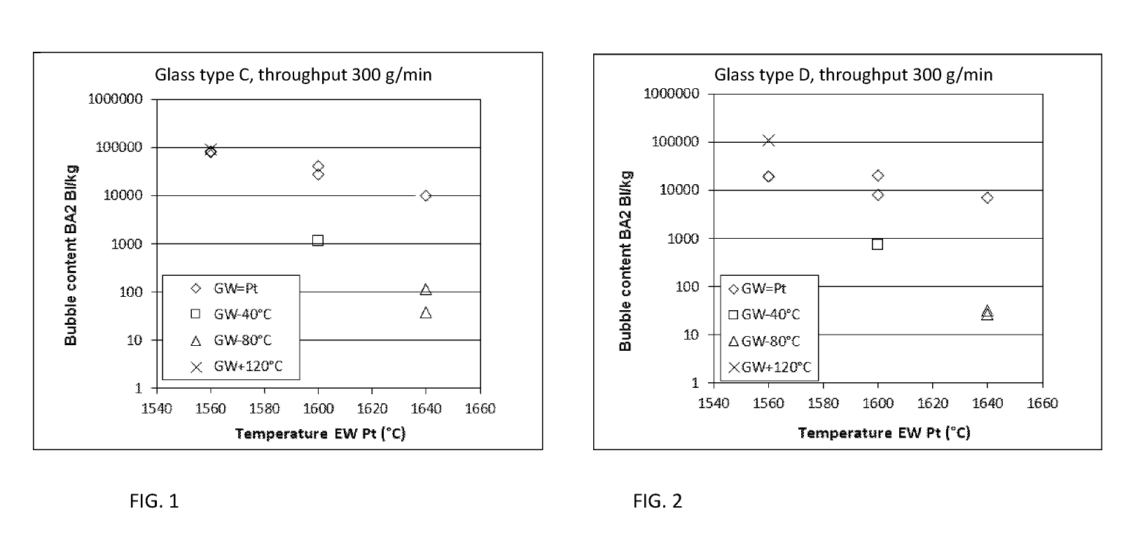

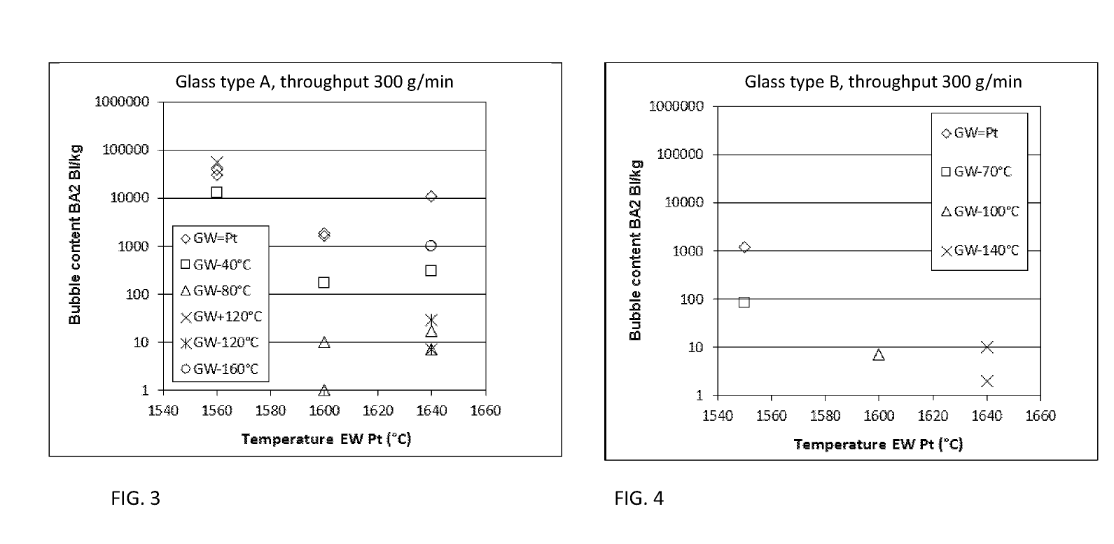

Exemplary working examples are shown in FIGS. 1-4. FIGS. 1 to 4 show working examples that show the bubble content and temperature distribution achievable in accordance with the invention for the selected glass types A, B, C and D according to Tables 3 and 4.

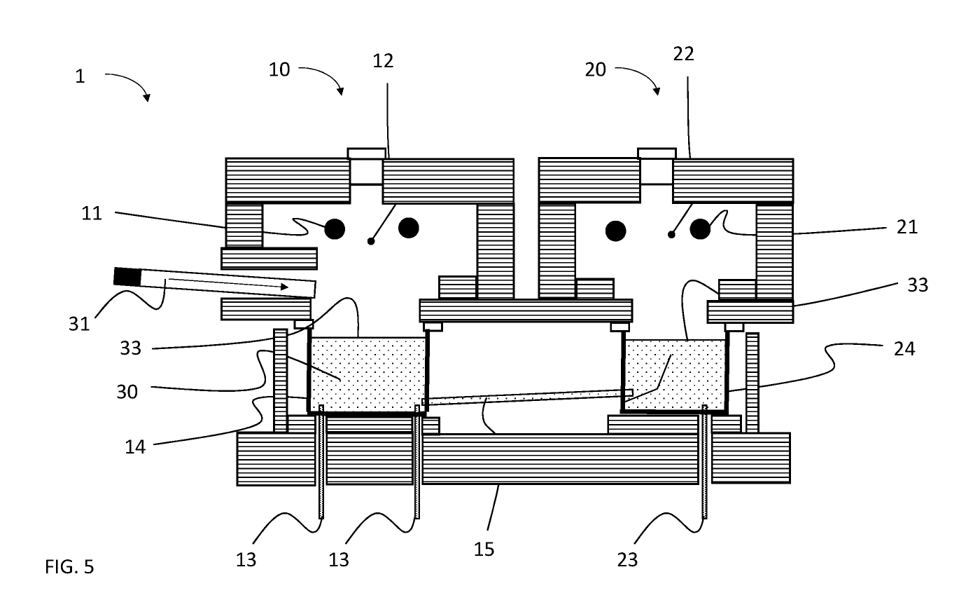

FIGS. 5 to 13 show working examples of melting apparatuses provided according to the invention.

FIG. 5 shows, by way of example, a melting apparatus identified in its entirety by reference numeral 1 in a longitudinal section. The melting apparatus 1 shown merely by way of example without restriction to this working example is in a two-part design and, in this embodiment, comprises a melting tank 10 and a refining tank 20, where each of the two tanks has a separate top furnace 12, 22 in construction terms. In the region of the top furnace 12, 22 there are disposed gas burners 11, 21 secured on a side wall of the top furnace 11, 21. In the example, for the sake of clarity, only two gas burners 11, 21 are shown in each case. A different number of gas burners 11, 21 is also possible and is indeed appropriate in the case of melting apparatuses 1 of greater dimensions, in which case the number and arrangement are guided by the desired energy input and/or the geometry and dimension of the top furnace 12, 22.

A feed device 31 is shown in schematic form, with which glass raw materials can be introduced into the charging region which, in this example, is integrated into the melting tank 10. The melting tank 10 defines a volume designed for melting of the glass raw materials supplied. In the example depicted, this volume 14 is filled with the glass melt 30, i.e. with at least partly molten glass raw materials. At the stage of filling with glass raw materials, the surface of the volume 14 forms what is called the glass line 33.

In the example, the melting tank 10 is also equipped with two base outlets 13, which allow liquid glass melt to be drawn off at the bottom.

The refining tank 20 also has a volume 24 for accommodation of glass melt 30. The two volumes 14, 24 are connected to one another via a feed 15, also referred to as throat. In the example, the refining tank 20 is also designed with a base outlet 23, via which homogenized and refined glass melt can be drawn off.

The melting apparatus 1 depicted in FIG. 5, comprising the melting tank 10 and the refining tank 20, was used to ascertain the parameters of the successful examples (Examples 1a-4) detailed in Tables 3 and 4 shown above and of the unsuccessful examples (Examples 6-10b) for the temperature and process regime of the melting apparatus.

The examples shown in the tables describe the differences in the glass qualities of the glass types studied with equal melt outputs but different process temperatures.

The successful examples 1a to 4, by comparison with the unsuccessful examples 6 to 10b, show that, given an equal construction size of the melting apparatus 1, on employment of the temperatures that are optimal in accordance with the invention, it is possible to achieve an increase in load by a factor of 2 or even more. In the case of inventive temperature or process control of the melting apparatus 1, it is accordingly possible to increase the specific melt output of about 0.8 t/m²/d to a specific melt output of more than 2 t/m²/d.

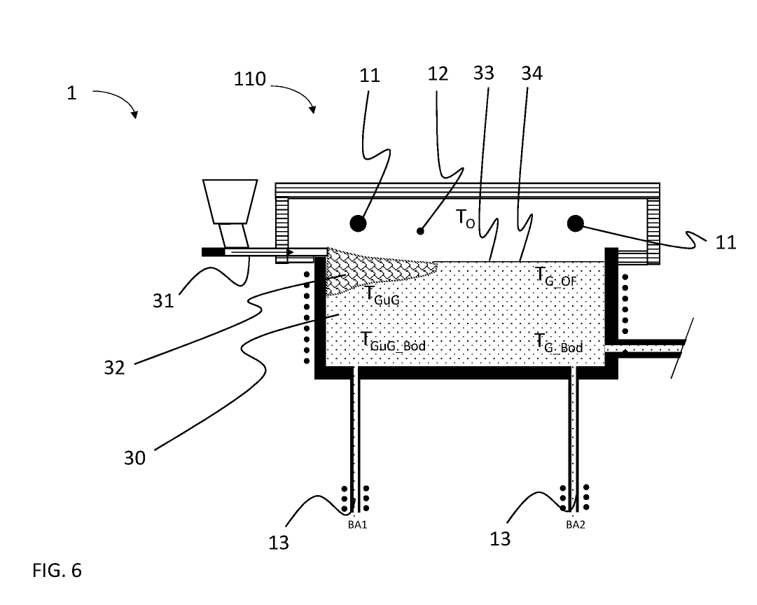

FIG. 6 shows a schematic of a melting apparatus 1 in a longitudinal section of a further exemplary embodiment of a melting tank 110 for elucidation of the process regime as a process model. A feed device 31 introduces glass raw materials into the melting tank 110, and these form a batch carpet 32 in the charging region. This batch carpet 32 partly covers the surface of the glass melt at the level of the glass line 33. In the example depicted, the surface is covered to an extent of about ⅓ with charged glass raw materials that have predominantly not yet melted. The thickness of the batch carpet 32 decreases viewed in production direction, meaning that it is at its greatest in the charging region.

FIG. 6 also shows, in schematic form, some regions as measurement points for ascertaining the relevant temperatures for the process regime. These include the temperature in the top furnace T_{O}, the glass temperature below the batch T_{GuG}, the glass temperature below the batch at the base T_{G_BOD}, the glass temperature at the clear glass bath surface T_{G_OF}, and the glass temperature in the region below the clear glass bath surface at the base T_{G_Bod}. The interface region between batch carpet 32 and clear surface is generally fluid in the process. The clear surface of the glass melt, i.e. the clear glass bath surface 34, is understood here to mean a surface region essentially free of unmolten glass raw materials, especially one covered to an extent of less than 80%, such as to an extent of less than 70% or to an extent of less than 60% by unmolten glass raw materials. Accordingly, at least 20%, such as at least 30% or at least 40% of the surface area of the glass melt described as clear is free of batch and/or glass shards.

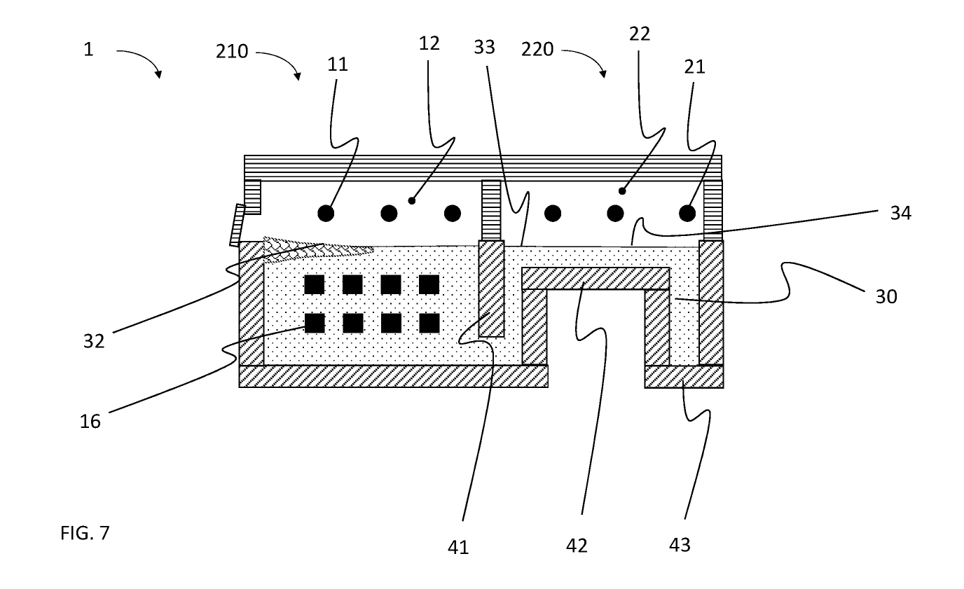

FIG. 7 shows, in schematic form, a further exemplary embodiment of a melting apparatus 1 in a longitudinal section with a melting tank 210 and a refining tank 220. The parameters according to Example 5 in Tables 3 and 4 were ascertained in a plant of this embodiment. The melting tank 210 and the refining tank 220 each have gas burners 11, 21 disposed in the region of the top furnace 12, 22. The top furnaces 12, 22 are separated in construction terms by an immersed barrier 41, which projects from the dome of the top furnace 12, 22 down to the glass melt 30.

Shown in schematic form are block or plate electrodes 16 designed as side electrodes, which are disposed in the region of the glass melt of the melting tank 210. Also provided between the melting tank 210 and the refining tank 220 is an overflow wall 42, the upper edge of which is below the glass line 33, and so glass melt can pass into the refining tank 220. Also provided is a throat 43 for drawing off the refined glass. The number of gas burners 11, 21 shown and the number of block or plate electrodes 16 is selected solely for illustration of the arrangement and installation position and may differ in the real melting apparatus.

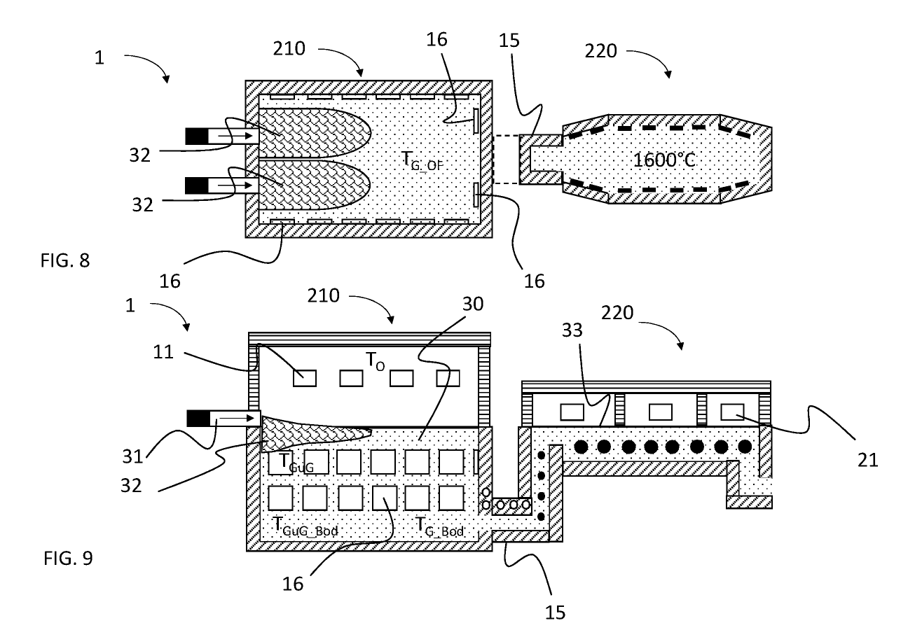

FIG. 8 and FIG. 9 show the construction of the melting apparatus from FIG. 7 in further views. FIG. 8 shows the two-part melting apparatus 1 in a top view, and FIG. 9 the same melting apparatus 1 in a longitudinal section. The melting apparatus 1 depicted by the way of example comprises a melting tank 210 and a refining tank 220, which are connected to one another via a throat 15. In the top view shown in FIG. 8, the arrangement of the plate electrodes 16 both on the two side walls and at the end face of the melting tank 210 is readily apparent.

It is apparent in FIG. 9 that these plate electrodes 16 are mounted below the glass line 33. In this example, the batch carpet 32 is larger and encompasses about half the surface area of the glass melt 30. Likewise shown are the regions in which the temperatures of the melting apparatus 1 of relevance for the process regime are ascertained.

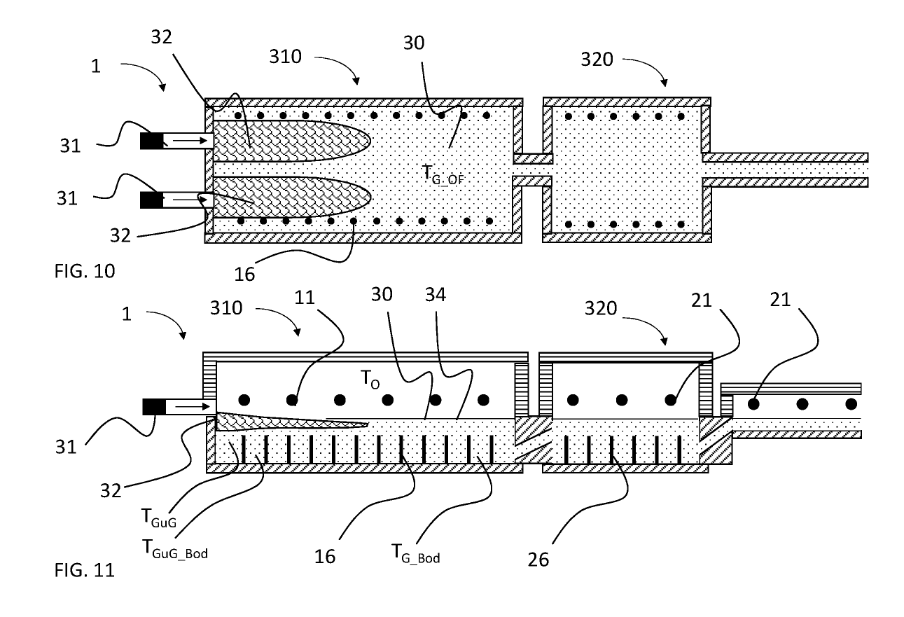

FIG. 10 and FIG. 11 show a further embodiment of a two-part melting apparatus 1 with side electrodes that has a melting output of more than 25 tons/day. In this example, the electrodes 16 are designed as rod electrodes and provided in a transverse arrangement in the melting tank 310, wherein the electrodes 16 project into the glass melt 30 via openings in the base of the melting tank 310 and in this way allow a highly exact temperature regime even in the glass melt close to the base. In addition, in the top furnace, both in the melting tank 310 and in the refining tank 320, fossil-fueled heating is provided, in the example in the form of gas burners 11, 21.

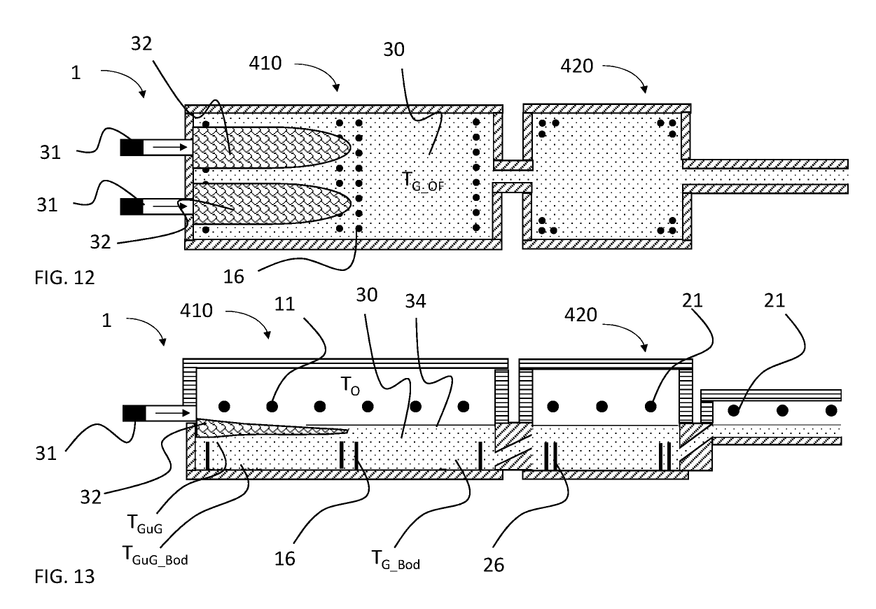

FIG. 12 and FIG. 13 show a further exemplary embodiment of a two-part melting apparatus 1 with side electrodes, which has a melting output of more than 25 tons/day. In this example, the electrodes 16 are likewise designed as rod electrodes and are provided in a longitudinal arrangement in the melting tank 410, wherein the electrodes 16 project into the glass melt 30 via openings in the base of the melting tank 410 and in this way allow a highly exact temperature regime even in the glass melt close to the base. In addition, in the top furnace, both in the melting tank 410 and in the refining tank 420, fossil-fueled heating is provided, in the example in the form of gas burners 11, 21.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A process for producing glass products from a glass melt, the process comprising:
providing glass raw materials;
heating the glass raw materials in a melting apparatus, the melting apparatus comprising a melting tank configured to produce a glass melt from the glass raw materials and a top furnace, the glass raw materials covering at least part of a surface of a melting region of the melting apparatus and at least a small portion of the surface of the melting region is not covered;
heating the melting apparatus in such a way that a temperature T^{G_BOD} of the glass melt at a base below a clear surface of the melting apparatus and a temperature T_{O} of an atmosphere in the top furnace are each at least 1300° C., wherein a vertical temperature difference T_{G_BOD}−T_{O} of at least 50° C. is established, and wherein the temperature of the glass melt at the base is greater than the temperature of the atmosphere in the top furnace, such that: T_{G_BOD}>T_{O}; and
discharging the glass melt from the melting tank.

2. The process of claim 1, wherein the discharged glass melt has fewer than 1000 bubbles/kg having a diameter of greater than 50 μm.

3. The process of claim 2, further comprising refining the discharged glass melt, wherein the refining reduces the number of bubbles in the refined glass such that the refined glass has less than 10 bubbles/kg having a diameter greater than 50 μm.

4. The process of claim 1, wherein the vertical temperature difference T_{G_BUD}−T_{O} is at least 100° C.

5. The process of claim 1, wherein a horizontal temperature difference between a temperature T_{GuG_BOD} of the glass melt at the base below a batch carpet and the temperature T_{G_BOD} of the glass melt at the base below the clear surface is less than 80° C.

6. The process of claim 1, wherein a ratio of a minimum dwell time tₘᵢₙ of the glass melt in the melting tank to an average geometric dwell time t_{geo} of the glass melt in the melting tank t_{geo}/tₘᵢₙ is not more than 6.

7. The process of claim 6, wherein the average geometric dwell time t_{geo} is less than 100 hours.

8. The process of claim 1, wherein a coverage of a glass surface of the melting region with glass raw materials is more than 30% of an available surface area.

9. The process of claim 1, wherein the compositions of the glass raw materials are selected for production of glass products comprising borosilicate, aluminosilicate or boroaluminosilicate glasses or lithium aluminum silicate glass ceramics.

10. The process of claim 1, wherein the composition of the glass raw materials is free of refining agents.

11. The process of claim 1, wherein the composition of the glass raw materials comprises refining agents.

12. The process of claim 1, wherein the heating of the glass melt comprises using at least one an electrical heating device or a fossil-fueled heating device.

13. The process of claim 12, wherein energy input for heating of the glass melt is introduced by a combination of fossil-fueled and electrical heating devices.

14. The process of claim 13, wherein at least 25% and at most 75% of the energy input is introduced by electrical heating devices.

15. The process of claim 1, further comprising providing electrical heating that acts over a full area.

16. The process of claim 1, wherein the glass melt is electrically heated under the surface covered with the glass raw materials.

17. The process of claim 1, wherein the melting apparatus comprises at least one of:
a charge region;
a discharge device configured to discharge the glass melt;
electrodes configured to provide electrical heat;
a bridge wall; or
an immersed barrier designed with or without separation in the top furnace.

18. A melting apparatus for production of glass products from a glass melt, the melting apparatus comprising:
a melting tank configured to generate a glass melt from glass raw materials and a top furnace;
a feed device configured to feed the glass raw materials, wherein the feeding is effected in such a way that the fed glass materials cover at least part of a surface of a melting region of the melting apparatus;
a heating device configured to heat the glass melt in such a way that a temperature T_{G_BOD} of the glass melt at a base below a clear surface of the melting apparatus and a temperature T_{O} of an atmosphere in the top furnace are each at least 1300° C., wherein a vertical temperature difference T_{G_BOD}−T_{O} of at least 50° C. is established and the temperature of the glass melt at the base is greater than the temperature of the atmosphere in the top furnace, such that: T_{G_BOD}>T_{O}; and
a discharge device configured to discharge the glass melt from the melting tank.

19. The melting apparatus of claim 18, further comprising a refining device configured to refine the glass melt discharged from the melting tank.

20. The melting apparatus of claim 18, wherein the heating device comprises at least one of an electrical heating device or a fossil-fueled heating device.

21. The melting apparatus of claim 20, wherein the heating device comprises an electrical heating device configured to provide electrical heating that acts over a full area.
